(19) United States
(12) Patent Application Publication
(10) Pub. No.: US 2008/0085980 A1
(43) Pub. Date: Apr. 10, 2008

(54) Process for the preparation of alkenyl-containing polyglycerol derivatives

(75) Inventor: Yuichi Sakanishi, Hiroshima (JP)

Correspondence Address: BIRCH STEWART KOLASCH & BIRCH, PO BOX 747, FALLS CHURCH, VA, 22040-0747, US

(73) Assignee: DAICEL CHEMICAL INDUSTRIES, LTD.

(21) Appl. No.: 11/898,500

(22) Filed: Sep. 12, 2007

(30) Foreign Application Priority Data
Sep. 13, 2006 (JP) 2006-247792

(51) Int. Cl. C08F 2/00; C08F 4/46

(52) U.S. Cl. 526/173

(57) ABSTRACT

An alkenyl-containing polyglycerol derivative is prepared by carrying out ring-opening polymerization of glycidol with a hydroxyl-containing compound in the presence of an alkali catalyst. The hydroxyl-containing compound is represented by following Formula (1): 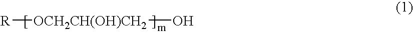 wherein R represents an alkenyl group containing three to five carbon atoms and having a terminal double bond; and “m” denotes 0 or 1. In this process, the ring-opening polymerization is carried out at a concentration of the alkali catalyst of 4 to 20 percent by mole relative to the hydroxyl-containing compound, at an addition reaction temperature of glycidol to the hydroxyl-containing compound of 0° C. to 100° C., in an amount of the glycidol of 1 to 10 moles per 1 mole of the hydroxyl-containing compound.

### BACKGROUND OF THE INVENTION

1. Field of the Invention

The present invention relates to a process for the preparation of a polyglycerol derivative containing an alkenyl group with a terminal double bond. More specifically, it relates to a process for the preparation of an alkenyl-containing polyglycerol derivative which contains less amounts of unreacted glycidol and by-produced polyglycerols.

2. Description of the Related Art

Polyoxyalkylene derivatives containing an alkenyl group with a terminal double bond, in particular allyl-containing polyoxyalkylene derivatives, have been industrially widely used as modification materials (modifiers) for reactive dimethylpolysiloxane having a Si—H group; and as raw materials for copolymerization with reactive monomers having a double bond. Among them, derivatives having a polyoxyethylene chain are hydrophilic and have thereby been used as resin modifiers for introducing a hydrophilic segment into a resin skeleton. In addition, alkenyl-containing polyglycerol derivatives have been known as materials having higher hydrophilicity.

Examples of known processes for the preparation of such alkenyl-containing polyglycerol derivatives include (1) a process of carrying out a ring-opening reaction of glycidol with allyl alcohol and (2) a process of carrying out a ring-opening reaction of allyl glycidyl ether with diglycerol (e.g., Japanese Examined Patent Application Publication (JP-B) No. S62-34039); as well as (3) a process of carrying out a ring-opening reaction of glycidol with glycerol monoallyl ether (e.g., Japanese Unexamined Patent Application Publication (JP-A) No. 2004-277548).

The process (1) uses boron trifluoride as a catalyst for the ring-opening reaction of glycidol with allyl alcohol, and purification to remove the catalyst is carried out using magnesium silicate adsorbent. However, the amount of the adsorbent is relatively large (for example, 3.5 percent by weight in Examples of JP-B No. S62-34039), a reaction product (synthesized product) has a high viscosity, and the filtration of such a highly viscous reaction product invites industrial disadvantages in yield and production time.

Besides the above-mentioned preparation process, it is possible to use an alkali catalyst for a ring-opening reaction of glycidol with allyl alcohol. In this case, however, the double bond of allyl group undergoes internal rearrangement from the alpha-position to the beta-position and is converted into propenyl group which is poor in reactivity. In addition, an aldehyde is formed from propenyl alcohol as a result of rearrangement and causes a Cannizzaro reaction to form a reduced substance; and the reduced substance decreases the reactivity in silicone modification reaction and in copolymerization reaction with a reactive monomer and causes an odor.

In the process (2) of adding an allyl glycidyl ether to diglycerol, the reaction product contains large amounts of a self-polymerization product of allyl glycidyl ether and unreacted diglycerol, and this adversely affects the performance of the resulting silicone-modified product.

The process (3) of carrying out a ring-opening reaction of glycidol with glycerol monoallyl ether is disadvantageous in that a polyglycerol forms at a high rate, because sodium hydroxide is added in a small amount, the reaction is carried out at a high temperature, and the reaction between glycidol molecules proceeds on a priority basis in a crude reaction mixture.

### SUMMARY OF THE INVENTION

According to the known processes, an alkenyl-containing polyglycerol derivative can be prepared, for example, through a ring-opening addition reaction of glycidol to glycerol monoallyl ether. In this reaction, part of glycidol, polyglycerol, and propenyl group is decomposed into propionaldehyde. The propionaldehyde has a significant odor, and it presents an unpleasant odor in a synthesized product even when it is contained in a very small amount. However, alkenyl-containing polyglycerol derivatives are expected to be used as raw materials for silicone-modified products for use mainly in cosmetic additives and the like, and therefore when alkenyl-containing polyglycerol derivatives contain such odorous components, they are significantly disadvantageous for use in cosmetic additives.

In the presence of hydroxide ion derived typically from sodium hydroxide, propionaldehyde is attacked by the hydroxide ion on its carbonyl carbon, and then, hydride ion is generated, thereby causing reduction of another unsaturated bond (Cannizzaro reaction). In addition, a very large amount of a polyglycerol as a self-polymerization product of glycidol is formed under some reaction conditions. When an alkenyl-containing polyglycerol derivative containing large amounts of by-products including reduced substances and polyglycerols is applied to a silicone-modification reaction, the functions of a product after silicone modification decreases with increasing amounts of the by-products, because the by-products are compounds which do not undergo silicone modification.

Accordingly, it is desirable to prepare a polyglycerol derivative containing an alkenyl group having one terminal double bond in a high yield and to reduce the formation rate of a polyglycerol. It is also desirable to reduce the occurrence of internal rearrangement and reduction of double bond. Specifically, it is desirable to provide a process for safely and efficiently preparing an alkenyl-containing polyglycerol derivative that is of high quality and contains by-products, if any, in very small amounts.

After intensive investigations, the present inventors have found that such a desirable process can be provided by carrying out a reaction of glycidol with a hydroxyl-containing compound represented by Formula (1) to yield an alkenyl-containing polyglycerol derivative in the presence of an alkali catalyst (base) under conditions of a concentration of the alkali catalyst and a reaction temperature within specific ranges so as to carry out the reaction at such a temperature that the reaction mixture can be sufficiently stirred. The present invention has been made based on these findings.

Specifically, according to an aspect of the present invention, there is provided a process for the preparation of an alkenyl-containing polyglycerol derivative. This process includes the step of carrying out ring-opening polymerization of glycidol with a hydroxyl-containing compound in the presence of an alkali catalyst, in which the hydroxyl-containing compound is represented by following Formula (1): 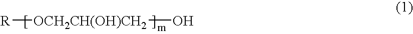
wherein R represents an alkenyl group containing three to five carbon atoms and having a terminal double bond; and “m” denotes 0 or 1. In this process, the ring-opening polymerization is carried out at a concentration of the alkali catalyst of 4 to 20 percent by mole relative to the hydroxyl-containing compound, at an addition reaction temperature of glycidol to the hydroxyl-containing compound of 0° C. to 100° C., in an amount of the glycidol of 1 to 10 moles per 1 mole of the hydroxyl-containing compound.

Preferably, the hydroxyl-containing compound represented by Formula (1) may be glycerol monoallyl ether. Preferably, the process for the preparation of the alkenyl-containing polyglycerol derivative further includes the steps of treating a reaction mixture containing the alkenyl-containing polyglycerol derivative and the alkali catalyst with an acid to form a salt; adding a solvent to the reaction mixture after the acid treatment to dissolve the alkenyl-containing polyglycerol derivative in the solvent, in which the solvent serves as a poor solvent for the salt but serves as a good solvent for the alkenyl-containing polyglycerol derivative; and separating and removing the salt from the alkenyl-containing polyglycerol derivative. According to another aspect of the present invention, there is provided an alkenyl-containing polyglycerol derivative prepared by the process according to the aspect of the present invention, in which the derivative contains less impurities.

A reaction product prepared by a process according to an embodiment of the present invention contains less amounts of unreacted glycidol and by-produced polyglycerols, in which the internal rearrangement of an alkenyl group having a terminal double bond is suppressed. There is thus provided a process for safely and efficiently preparing a polyglycerol derivative containing an alkenyl group having one terminal double bond, which contains very small amounts of by-products and is of high quality.

### BRIEF DESCRIPTION OF THE DRAWINGS

FIG. 1 shows ¹H-NMR analysis data of a compound prepared according to Example 1;

FIG. 2 shows ¹H-NMR analysis data of a compound prepared according to Example 2; and

FIG. 3 shows ¹H-NMR analysis data of a compound prepared according to Comparative Example 1.

### DESCRIPTION OF THE PREFERRED EMBODIMENTS

A process for the preparation of an alkenyl-containing polyglycerol derivative according to an embodiment of the present invention includes the steps of adding an alkali catalyst to the hydroxyl-containing compound represented by Formula (1) (hereinafter referred to as “hydroxyl-containing compound (1)”) to convert the compound into an alkoxide, and adding glycidol thereto so as to carry out a reaction at such a temperature as to enable sufficient stirring.

In Formula (1), R is an alkenyl group containing three to five carbon atoms and having one terminal double bond and is not particularly limited. Examples thereof include 2-propenyl group (allyl group), 2-methyl-2-propenyl group (methallyl group), 3-butenyl group, and 3-methyl-3-butenyl group, of which allyl group is preferred. The repetition number “m” denotes 0 or 1.

Specific examples of the hydroxyl-containing compound (1) for use in the present invention include olefinic alcohols such as 2-propen-1-ol (allyl alcohol), 2-methyl-2-propen-1-ol (methallyl alcohol), 3-buten-1-ol, and 3-methyl-3-buten-1-ol; as well as glycerol monoallyl ether and glycerol monomethallyl ether. Among them, glycerol monoallyl ether represented by following Formula (2) is preferred, because this compound can be dealt with good workability and the resulting polyglycerol derivative is stable in molecular weight
CH₂═CHCH₂—OCH₂CH(OH)CH₂—OH (2)

In this connection, the glycerol monoallyl ether can be obtained, for example, by subjecting a hydrolyzed product of allyl glycidyl ether hydrolyzed at its epoxy group to distillation or by subjecting an ether between glycerol and allyl chloride to distillation.

The process may be carried out so that the hydroxyl-containing compound (1) is placed in a reactor; an alkali catalyst is added thereto to convert the hydroxyl-containing compound (1) into an alkoxide; and a reaction is carried out while glycidol is added in small portions.

This reaction is carried out at a temperature of 0° C. to 100° C., preferably 30° C. to 90° C., and more preferably 50° C. to 80° C. If the reaction temperature is lower than 0° C., a reaction mixture is not sufficiently stirred during the reaction, thus being not preferred. If it is higher than 100° C., glycidol undergoes self-polymerization before the reaction with the alkoxide, thus causing by-production of a polyglycerol, thus being not preferred.

A low-boiling-point compound and/or inert solvent which is not reactive with glycidol may be added upon the reaction in order to prevent the reaction temperature from elevating and to reduce the viscosity of a crude reaction mixture. Examples of such a compound or solvent include acetone, ethyl acetate, butyl acetate, hexane, toluene, and xylenes.

The reaction should be carried out under flow of an inert gas such as nitrogen gas, in order to suppress the hydrolysis of the alkoxide. If not, the alkoxide is hydrolyzed to form an alkali compound, and the alkali compound acts as an initiator to cause by-production of a polyglycerol. Where necessary, the reaction may be performed under a pressure (under a load).

In the reaction, the alkali catalyst (reaction catalyst) is added to the hydroxyl-containing compound (1) before glycidol is added thereto. The concentration of the alkali catalyst is 4 to 20 percent by mole, and preferably 5 to 10 percent by mole relative to the hydroxyl-containing compound (1). If the catalyst concentration is less than 4 percent by mole, glycidol undergoes self-polymerization before the reaction with the alkoxide, thus causing by-production of a polyglycerol, thus being not preferred. If it exceeds 20 percent by mole, a reduced substance is by-produced in a large amount, thus being not preferred. The catalyst may be added to the reaction system in one portion or in two or more portions. To accelerate the conversion of the hydroxyl-containing compound (1) into an alkoxide, the conversion may be carried out after the addition of the catalyst, where necessary, with heating or with heating under reduced pressure while distilling water.

The alkali catalyst for use in the present invention is a basic compound and is preferably such a basic compound that, after the hydroxyl-containing compound (1) is converted into an alkoxide, the residual catalyst can be easily removed. The basic compound is not particularly limited; and examples thereof include basic compounds each corresponding to a protic solvent, except for an alkali metal or alkaline earth metal cation replacing a part of protons of the protic solvent, such as potassium hydroxide, sodium hydroxide, lithium hydroxide, magnesium hydroxide, calcium hydroxide, sodium methoxide, sodium ethoxide, potassium methoxide, potassium ethoxide, potassium butoxide, and sodium butoxide; basic compounds each corresponding to a saturated hydrocarbon, except for an alkali metal or alkaline earth metal cation replacing a part of saturated hydrocarbons, such as butyllithium, methyllithium, ethyllithium; and basic metals such as metallic sodium, metallic potassium, and metallic lithium. Each of these catalysts can be used alone or in combination.

As a result of the above-mentioned reaction, glycidol is added to and polymerized with the hydroxyl-containing compound (1) to yield an alkenyl-containing polyglycerol derivative represented by following Formula (3), having a high degree of polymerization. Following Formula (3) is expressed such that an ether bond is formed only through the primary alcohol of glycerol, however, the product may contain a component in which an ether bond is formed through the secondary alcohol of glycerol.

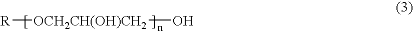

In Formula (3), R represents an alkenyl group which has a terminal double bond and contains three to five carbon atoms; and “n” denotes the average number of glycerol monomer. This number equals to the molar ratio of glycidol to be reacted and can be easily changed. The number “n” is a number exceeding 2, is preferably 3 or more, and more preferably 3 to 10.

A compound from which a salt derived from the alkali catalyst has been removed can be obtained by carrying out purification after the ring-opening polymerization of glycidol using the alkali catalyst in a preparation process according to an embodiment of the present invention. The purification can be carried out, for example, in the following manner.

In a purification step according to an embodiment of the present invention, the alkali catalyst is neutralized with an acid to precipitate a salt derived from the catalyst, such as an alkali metal salt. The precipitated salt is removed by filtration. For easily performing the filtration, the reaction mixture may be diluted with a solvent that serves as a poor solvent for the salt but serves as a good solvent for the alkenyl-containing polyglycerol derivative so as to reduce the viscosity of the reaction mixture.

The acid for use in the purification is not particularly limited and can be, for example, an inorganic acid such as phosphoric acid, sulfuric acid, hydrochloric acid, or nitric acid; or an organic acid such as acetic acid, formic acid, butyric acid, or valeric acid. Among them, hydrochloric acid and/or phosphoric acid is preferred.

When a solvent is added upon the filtration, the solvent should be a solvent serving as a poor solvent for a catalyst-derived salt, such as an alkali metal salt, but serving as a good solvent for a polyether (the alkenyl-containing polyglycerol derivative). Examples of such solvents include alcohols, pentane, hexane, octane, benzene, acetone, ethyl acetate, and diethyl ether, of which alcohols are preferred. Such alcohols for use as the solvent are not particularly limited and examples thereof include saturated aliphatic alcohols such as methanol and ethanol; unsaturated aliphatic alcohols; and aromatic alcohols such as phenol. The alcohol for use herein can have any structure such as a straight-chain structure, a branched-chain structure, or a cyclic structure. In addition, it can be a polyhydric alcohol such as a dihydric alcohol. The alcohol preferably has, but not limited to, one to eight carbon atoms, and more preferably one to four carbon atoms. Each of these solvents such as alcohols and nonpolar solvents can be used alone or in combination.

The amount of the solvent is not particularly limited; however, it should be such an amount that, when the solvent is added to a reaction mixture containing a polyether (alkenyl-containing polyglycerol derivative) and a catalyst-derived salt such as an alkali metal salt, the resulting mixture has a reduced viscosity so as to enable easy filtration of the resulting mixture. When the filtration device is, for example, a filter press that can apply a pressure of 4 kg/cm², the viscosity of the resulting mixture (solution) is preferably 30 cps or less.

After the filtration, the solvent is removed from the solution containing a polyether (alkenyl-containing polyglycerol derivative). Conditions for the desolvation, such as solution temperature and pressure in the system, are not particularly limited; however, the desolvation is preferably carried out under flow of an inert gas or under reduced pressure, so as to prevent the formation of by-products due typically to oxidation.

The resulting product is a product mainly containing an alkenyl-containing polyglycerol derivative. The content of an alkenyl-containing polyglycerol derivative as a main product in the product is 90% or more, and preferably 95% or more. The content of a polyglycerol as a by-product in the product is 10% or less, and preferably 5% or less. The content of a rearranged substance and a reduced substance as by-products in the product is preferably 0.5% or less, and more preferably 0.1% or less.

The content of the alkenyl-containing polyglycerol derivative in the product may be determined in the following manner. The product is eluted through column chromatography such as high-performance liquid chromatography (HPLC); peaks are detected with a differential refractometer; a peak area ratio of the alkenyl-containing polyglycerol derivative represented by Formula (3) is determined as the ratio of peak area belonging to the alkenyl-containing polyglycerol derivative to the total area; and the content of the alkenyl-containing polyglycerol derivative is expressed as the peak area ratio of the alkenyl-containing polyglycerol derivative. Likewise, the content of a polyglycerol in the product is expressed as the ratio of peak area belonging to the polyglycerol to the total peak area.

Examples of the column chromatography include reversed-phase partition-column chromatography using, as a carrier, a silica gel having octadecylsilyl group, octylsilyl group, butylsilyl group, trimethylsilyl group, or phenylsilyl group as a functional group; normal-phase partition column chromatography using, as a carrier, a silica gel having cyanopropyl group or aminopropyl group as a functional group; ion-exchange column chromatography using an ion-exchanger having quaternary ammonium group or phenylsulfonic acid group as a functional group; and adsorption column chromatography using a porous silica gel. Among such chromatography techniques, preferred is reversed-phase partition column chromatography using, as a carrier, a silica gel having octadecylsilyl (ODS) group as a functional group. For higher separation performance, the column for use herein preferably has dimensions of 4.6 mm in diameter and 250 mm or more in length. In addition, serial arrangement of two or more columns is more preferred for further higher separation performance.

The rearranged substance and reduced substance as by-products can be detected through ¹H-NMR analysis (nuclear magnetic resonance analysis). For example, chemical shifts of a rearranged substance and a reduced substance can be detected in a region of high magnetic fields of around 0.6 to 1.8 ppm under the after-mentioned conditions for ¹H-NMR analysis.

An alkenyl-containing polyglycerol derivative prepared by a process according to an embodiment of the present invention may further be purified according to necessity. Examples of the purification procedure include (i) a deodorizing procedure of supplying a heated saturated water vapor under reduced pressure to carry out deodorization with water vapor, and (ii) a decolorizing procedure such as bleaching with sodium hypophosphite or hydrogen peroxide.

As has been described above, a high-purity alkenyl-containing polyglycerol derivative product having a high content of the target alkenyl-containing polyglycerol derivative can be prepared by a process according to an embodiment of the present invention. In addition, a further satisfactory alkenyl-containing polyglycerol derivative product which is substantially free from a rearranged substance and a reduced substance can be prepared by using glycerol monoallyl ether as the hydroxyl-containing compound (1). Accordingly, an alkenyl-containing polyglycerol derivative prepared by a process according to an embodiment of the present invention can be advantageously used, for example, as a food additive. In addition, an alkenyl-containing polyglycerol derivative prepared by a process according to an embodiment of the present invention may be subjected to silicone modification, and the resulting silicone-modified derivative can be used as a cosmetic additive such as a surfactant or an emulsion stabilizer. In these applications, the alkenyl-containing polyglycerol derivative contributes to, for example, improved surface tension, improved dispersion power, improved foaming power, and/or improved emulsion stability.

The present invention will be illustrated in further detail with reference to several examples below; it should be noted, however, the following examples are never intended to limit the scope of the present invention. Compounds obtained below were analyzed according to the following methods.

(1) Conditions for HPLC Analysis

HPLC unit: Waters 2690 (Waters Corporation)

Column: Wakosil 5C18 (Wako Pure Chemical Industries, Ltd.; reversed-phase partition column having octadecylsilyl group as a functional group)

Eluent: methanol/H₂O (30/70)

Flow rate: 0.5 ml/min.

Temperature of column oven: 40° C.

Detection method: RI

Sample concentration: 10% (solvent: methanol/H₂O (30/70))

Sample amount: 10 μl

A polyglycerol has a retention time of 6 minutes, and a polyglycerol monoallyl ether has a retention time of 7 to 20 minutes.

(2) Conditions for ¹H-NMR Analysis

Unit: 270 MHz NMR Analyzer (JEOL, Ltd.)

Sample concentration: 1% (wt/wt)

Solvent: deuterated dimethyl sulfoxide (deuterated DMSO)

Internal standard: tetramethylsilane (TMS)

A polyglycerol monoallyl ether and a polyglycerol each have a chemical shift of 2.8 ppm to 6 ppm; and a rearranged substance and a reduced substance each have a chemical shift of 0.6 ppm to 1.8 ppm.

(3) Hydroxyl Value

The hydroxyl value was determined according to the method specified in Japanese Industrial Standards (JIS) K-0070.

(4) Viscosity

The viscosity was measured with a cone/plate viscometer (E type viscometer) according to the method specified in JIS K-7117-2.

(5) Iodine Number

The iodine number was determined according to the method specified in JIS K-0070.

### Example 1

In a 2-liter flask were placed 264 g (2 mol) of glycerol monoallyl ether and 8 g (0.2 mol) of sodium hydroxide; the inside atmosphere of the system was replaced with nitrogen gas; the temperature was raised to 80° C. while stirring; the pressure was reduced to 10 Torr; and dehydration was carried out for four hours. Next, the pressure was released, and the temperature was lowered to 60° C. In addition, 296 g (4 mol) of glycidol weighed in a measuring vessel was injected into the system at 70° C. under normal pressure over twelve hours, and the reaction was continued for further one hour. Next, 10 g (0.1 mol) of phosphoric acid was added to neutralize the system.

Thereafter, the temperature was lowered to 60° C., and 500 mL of methanol was added to yield a methanol solution with a precipitated neutralized salt. The neutralized salt was removed from the methanol solution through filtration, and methanol was then removed at 100° C. and 10 Torr to thereby yield 551 g of a compound.

The resulting compound had an average number of glycerol monomer of 3 and had a hydroxyl value of 802 KOH-mg/g (theoretical value: 800.7), a viscosity of 812 mPa·s (40° C.), an iodine number of 90.1 I₂-mg/100 mg (theoretical value: 90.5), and a polyglycerol content of 2.5 percent by area in LC. Substantially no rearranged substance and reduced substance was observed (0.1% or less) in the ¹H-NMR analysis, and the compound did not present an unpleasant odor.

### Example 2

In a 2-liter flask equipped with a 20-tray distillation column were placed 166 g (2.8 mol) of allyl alcohol and 10.8 g (0.2 mol) of sodium methoxide; the inside atmosphere of the system was replaced with nitrogen gas; the temperature was raised to 100° C. while stirring; the pressure was reduced to 10 Torr; and methanol removal was conducted for two hours under reflux. Next, the pressure was released, and the temperature was lowered to 60° C. Next, 444 g (6 mol) of glycidol weighed in a measuring vessel was injected into the system at 70° C. under normal pressure over twelve hours, and the reaction was continued for further one hour. Next, 10 g (0.1 mol) of phosphoric acid was added to neutralize the system. Thereafter, the temperature was raised to 100° C. and the pressure was reduced to 10 Torr to thereby remove 50 g of unreacted allyl alcohol. The temperature was lowered to 60° C., and 500 mL of methanol was added to yield a methanol solution with a precipitated neutralized salt. The neutralized salt was removed from the methanol solution through filtration, and methanol was then removed at 100° C. and 10 Torr to thereby yield 540 g of a compound.

The resulting compound had a hydroxyl value of 789 KOH-mg/g (theoretical value: 800.7), a viscosity of 821 mPa·s (40° C.), an iodine number of 84.1 I₂-mg/100 mg (theoretical value: 90.5), and a polyglycerol content of 3.5 percent by area in LC.

However, a rearranged substance and a reduced substance were observed (4.5%) in the ¹H-NMR analysis, and the compound presented an unpleasant odor.

### Comparative Example 1

In a 2-liter flask were placed 264 g (2 mol) of glycerol monoallyl ether and 0.4 g (0.01 mol) of sodium hydroxide; the inside atmosphere of the system was replaced with nitrogen gas; the temperature was raised to 80° C. while stirring; the pressure was reduced to 10 Torr; and dehydration was carried out for four hours. Next, the pressure was released; the temperature was raised to 110° C.; 296 g (4 mol) of glycidol weighed in a measuring vessel was injected into the system at 120° C. under normal pressure over twelve hours; and the reaction was continued for further one hour. Next, 0.5 g (0.005 mol) of phosphoric acid was added to neutralize the system. Thereafter, the temperature was lowered to 60° C., and 500 mL of methanol was added to yield a methanol solution with a precipitated neutralized salt. The neutralized salt was removed from the methanol solution through filtration, and methanol was then removed at 100° C. and 10 Torr to thereby yield 548 g of a compound.

The resulting compound had a hydroxyl value of 799 KOH-mg/g (theoretical value: 800.7), a viscosity of 832 mPa·s (40° C.), an iodine number of 89.1 I₂-mg/100 mg (theoretical value: 90.5), and a polyglycerol content of 12.3 percent by area in LC. Substantially no rearranged substance and reduced substance was observed (0.1% or less) in the ¹H-NMR analysis, and the compound did not present an unpleasant odor.

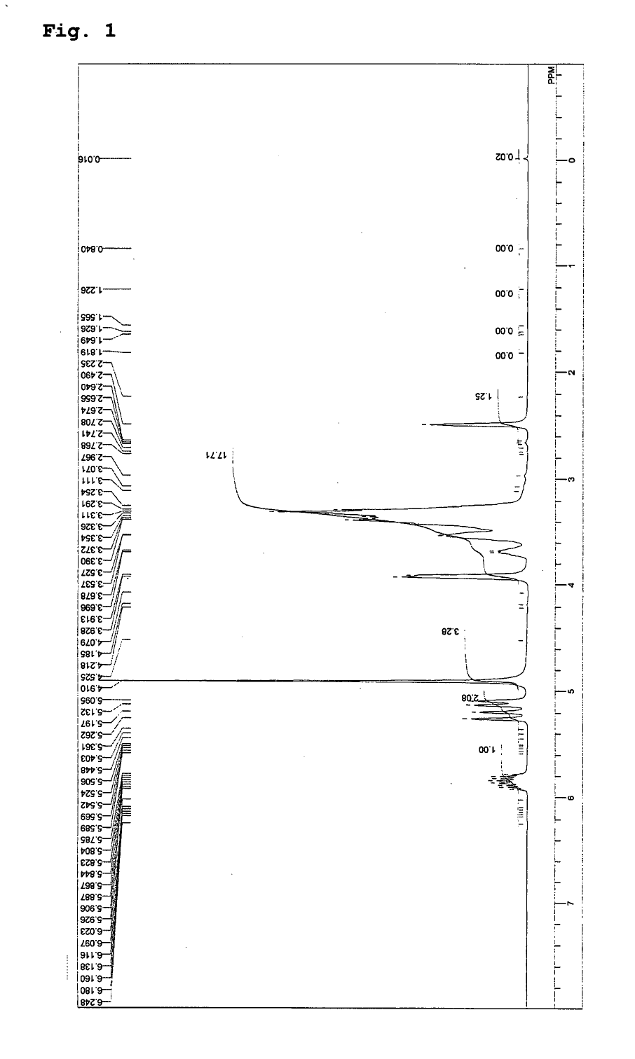

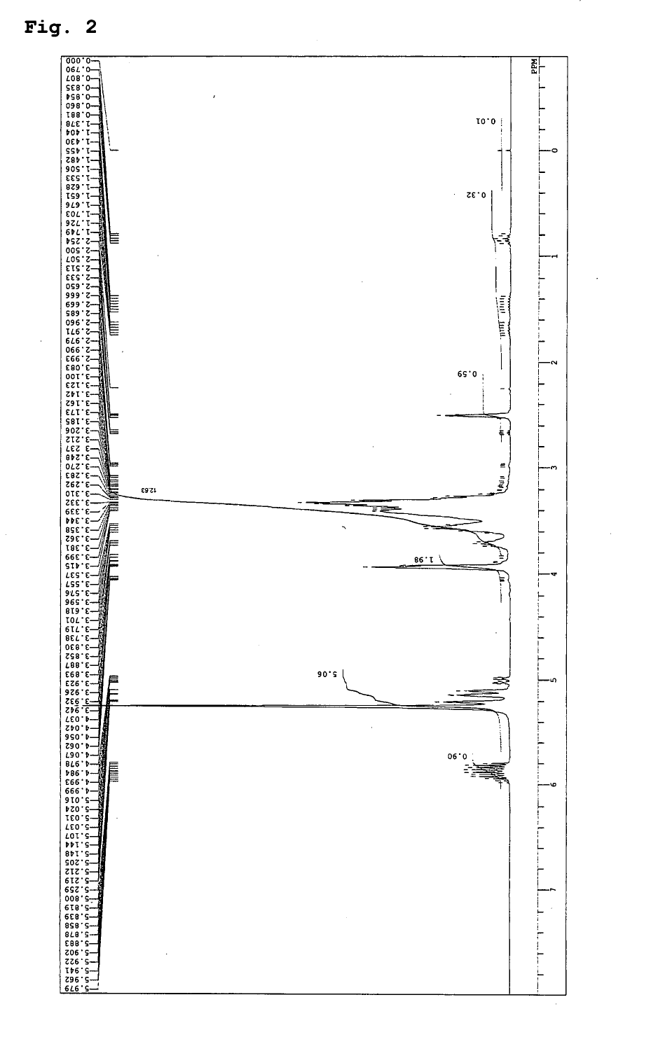

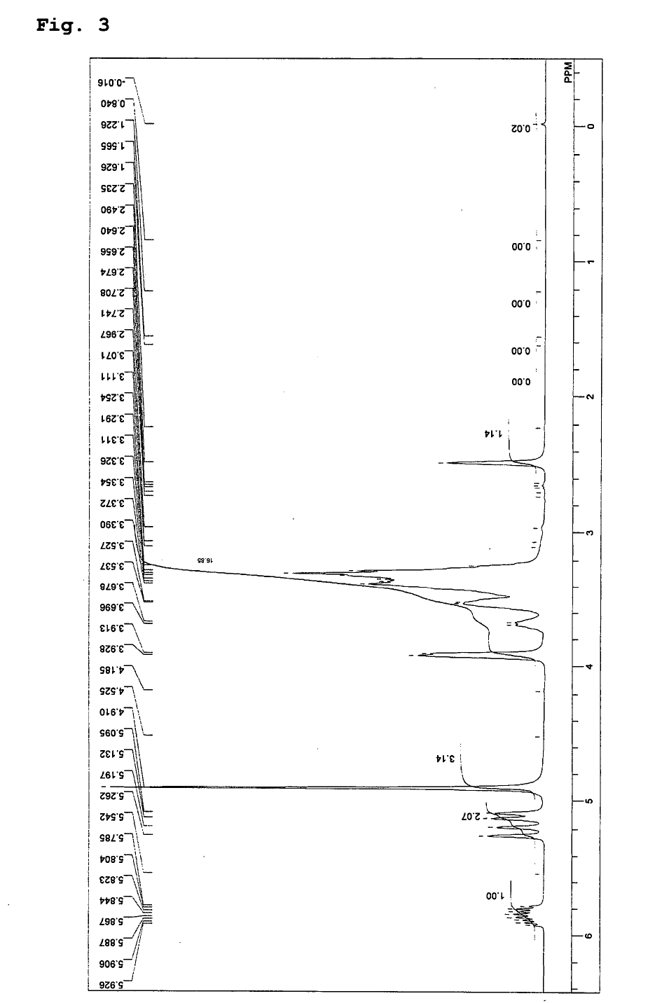

The results in ¹H-NMR analyses of Examples 1 and 2, and Comparative Example 1 are shown in FIGS. 1 to 3, respectively.

Other embodiments and variations will be obvious to those skilled in the art, and this invention is not to be limited to the specific matters stated above.

1. A process for preparation of an alkenyl-containing polyglycerol derivative, the process comprising the step of carrying out ring-opening polymerization of glycidol with a hydroxyl-containing compound in a presence of an alkali catalyst, wherein the hydroxyl-containing compound is represented by following Formula (1): 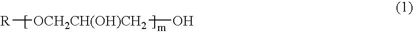
wherein R represents an alkenyl group containing three to five carbon atoms and having a terminal double bond; and “m” denotes 0 or 1, and
wherein a concentration of the alkali catalyst is 4 to 20 percent by mole relative to the hydroxyl-containing compound, a temperature of the polymerization of the glycidol with the hydroxyl-containing compound is 0° C. to 100° C., and an amount of the glycidol is 1 to 10 moles per 1 mole of the hydroxyl-containing compound.

2. The process for the preparation of the alkenyl-containing polyglycerol derivative of claim 1, wherein the hydroxyl-containing compound represented by Formula (1) is glycerol monoallyl ether.

3. A process for the preparation of the alkenyl-containing polyglycerol derivative of one of claims 1 and 2, the process further comprising the steps of:
treating a reaction mixture containing the alkenyl-containing polyglycerol derivative and the alkali catalyst with an acid to form a salt;
adding a solvent to the reaction mixture after the acid treatment to dissolve the alkenyl-containing polyglycerol derivative in the solvent, the solvent serving as a poor solvent for the salt but serving as a good solvent for the alkenyl-containing polyglycerol derivative; and
separating and removing the salt from the alkenyl-containing polyglycerol derivative.

4. An alkenyl-containing polyglycerol derivative prepared by the process of claim 1, which contains less impurities.
